(19) United States
(12) Patent Application Publication
(10) Pub. No.: US 2025/0357781 A1
(43) Pub. Date: Nov. 20, 2025

(54) UNINTERRUPTIBLE POWER SUPPLY DEVICE

(71) Applicant: TMEIC Corporation, Tokyo (JP)

(72) Inventors: Ryogo IMANISHI, Chuo-ku (JP); Kazunori SANADA, Chuo-ku (JP); Ryo MURATA, Chuo-ku (JP)

(73) Assignee: TMEIC Corporation, Tokyo (JP)

(21) Appl. No.: 18/871,686

(22) PCT Filed: Apr. 13, 2023
(86) PCT No.: PCT/JP2023/015065

§ 371 Date: Dec. 4, 2024

(51) Int. Cl. H02J 9/06

(52) U.S. Cl. CPC H02J 9/062

(57) ABSTRACT

This uninterruptible power supply device includes: a semiconductor switch that is connected between a bypass AC power supply and a load, is turned on when the bypass AC power supply is normal, and is turned off when the bypass AC power supply has a power failure; and an inverter that converts DC power supplied from an AC power supply or a battery into AC power and supplies the AC power to the load when the bypass AC power supply has a power failure, and supplies an assist current to the load if a load current is larger than a threshold current when the bypass AC power supply is normal, the assist current being a difference between the load current and the threshold current. Therefore, even if the load current is increased by load variation, the current flowing through the semiconductor switch can be maintained at the threshold current or lower.

### TECHNICAL FIELD

The present disclosure relates to an uninterruptible power supply device, and in particular, to an uninterruptible power supply device including a semiconductor switch and an inverter.

### BACKGROUND ART

For example, WO 2017/009998 (PTL 1) discloses an uninterruptible power supply device including a bypass switch, a small-sized semiconductor switch, and a power converter that are connected in parallel between an alternating current (AC) power supply and a load. The power converter includes a converter that converts AC power supplied from the AC power supply into direct current (DC) power, and an inverter that converts the DC power into AC power and supplies it to the load.

When the AC power supply is normal, an inverter power feed mode is performed, in which the bypass switch and the semiconductor switch are turned off. Further, the converter converts the AC power from the AC power supply into DC power. The DC power is stored in a battery, and is also provided to the inverter. The inverter converts the DC power into AC power and supplies it to the load.

When the inverter has a failure, a bypass power feed mode is performed, in which the operation of the power converter is stopped and the bypass switch and the semiconductor switch are turned on. In order to prevent overheating of the semiconductor switch by a current, the semiconductor switch is turned off after a lapse of a predetermined time. The AC power is supplied from the AC power supply to the load via the bypass switch.

When a power failure occurs in the AC power supply, a battery power feed mode is performed, in which the operation of the converter is stopped, and the inverter converts the DC power in the battery into AC power and supplies it to the load.

Therefore, even if a power failure occurs in the AC power supply, the operation of the load can be continued while the DC power is stored in the battery.

### CITATION LIST

### Patent Literature

PTL 1: WO 2017/009998

### SUMMARY OF INVENTION

### Technical Problem

However, such an uninterruptible power supply device has a problem that a loss is produced mainly in the power converter, resulting in a low efficiency of about 96%. As a measure thereof, an uninterruptible power supply device having a bypass ECO power feed mode has attracted attention. This uninterruptible power supply device includes a large-sized semiconductor switch and a power converter that are connected in parallel between an AC power supply and a load.

When the AC power supply is normal, a bypass ECO power feed mode is performed, in which the semiconductor switch is turned on, and AC power from the AC power supply is supplied to the load via the semiconductor switch. When a power failure occurs in the AC power supply, a battery power feed mode is performed, in which the semiconductor switch is turned off, an inverter included in the power converter converts DC power in a battery into AC power and supplies it to the load. Although a loss is produced mainly in the semiconductor switch in this uninterruptible power supply device, the loss in the semiconductor switch is smaller than the loss in the power converter, and thus a high efficiency of 99% is achieved.

In this uninterruptible power supply device, a semiconductor switch having a capacity required to supply a rated current of the load is generally used. However, this uninterruptible power supply device has a problem that, when a load current is increased by load variation to exceed a predetermined current, the semiconductor switch is turned off after a lapse of a predetermined time in order to prevent overheating of the semiconductor switch, and the operation of the load is stopped.

As a measure thereof, it is conceivable to adopt a method of using a semiconductor switch having a large capacity that can supply a current sufficiently larger than the rated current of the load. However, this method leads to device upsizing and cost increase.

Accordingly, a main object of the present disclosure is to provide a small-sized, low-cost uninterruptible power supply device that is tolerant of load variation.

### Solution to Problem

An uninterruptible power supply device of the present disclosure includes a semiconductor switch and an inverter. The semiconductor switch is connected between a first AC power supply and a load, is turned on when the first AC power supply is normal, and is turned off when the first AC power supply has a power failure. The inverter converts DC power supplied from a DC power supply into AC power and supplies the AC power to the load when the first AC power supply has a power failure, and supplies an assist current to the load if a load current is larger than a threshold current when the first AC power supply is normal, the assist current being a difference between the load current and the threshold current.

### Advantageous Effects of Invention

In the uninterruptible power supply device of the present disclosure, if the load current is larger than the threshold current when the first AC power supply is normal, the assist current, which is a difference between the load current and the threshold current, is supplied from the inverter to the load. Therefore, even if the load current is increased by load variation, the current flowing through the semiconductor switch can be maintained at the threshold current or lower, and overheating of the semiconductor switch can be prevented. This can prevent the semiconductor switch from being turned off to stop the operation of the load, and thus an uninterruptible power supply device that is tolerant of load variation can be implemented. Further, since there is no need to use a semiconductor switch having a large capacity in preparation for an increase in the load current, device downsizing and cost reduction can be achieved.

### BRIEF DESCRIPTION OF DRAWINGS

FIG. 1 is a circuit block diagram showing a configuration of an uninterruptible power supply device according to one embodiment of the present disclosure.

FIG. 2 is a block diagram showing a main portion of a control device shown in FIG. 1.

FIG. 3 is a block diagram showing a configuration of a portion related to the control of a semiconductor switch, of a control circuit shown in FIG. 2.

FIG. 4 is a time chart showing an operation of a control unit shown in FIG. 3.

FIG. 5 is a block diagram showing a configuration of a portion related to the control of an inverter, of the control circuit shown in FIG. 2.

FIG. 6 is a flowchart showing an operation of the uninterruptible power supply device shown in FIGS. 1 to 5.

FIG. 7 is a circuit block diagram for describing an operation of the uninterruptible power supply device during an inverter-assisted power feed mode.

FIG. 8 is a circuit block diagram for describing an operation of the uninterruptible power supply device during a battery power feed mode.

FIG. 9 is a circuit block diagram for describing an operation in a comparative example.

FIG. 10 is a circuit block diagram for describing another operation in the comparative example.

FIG. 11 is a view for describing an effect in the embodiment.

FIG. 12 is a circuit block diagram showing a variation of the embodiment.

### DESCRIPTION OF EMBODIMENTS

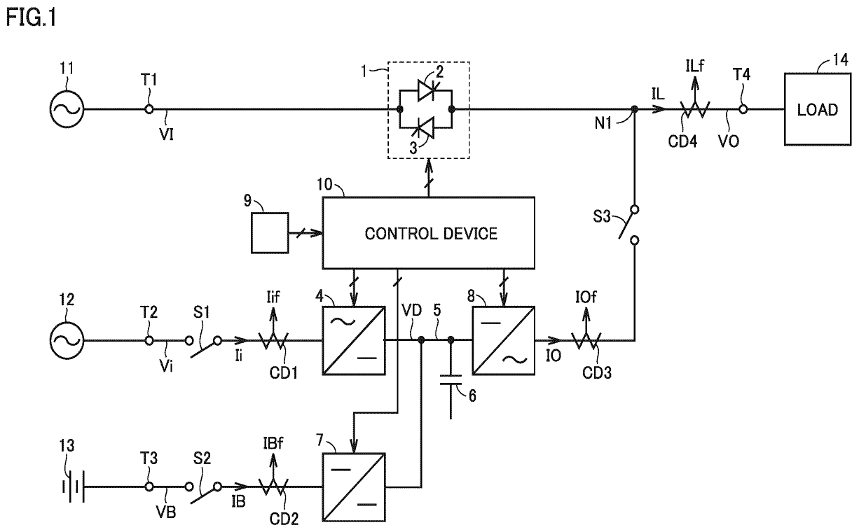

FIG. 1 is a circuit block diagram showing a configuration of an uninterruptible power supply device according to one embodiment of the present disclosure. In FIG. 1, this uninterruptible power supply device includes a bypass input terminal T1, an input terminal T2, a DC terminal T3, an output terminal T4, a semiconductor switch 1, switches S1 to S3, a converter 4, current detectors CD1 to CD4, a DC line 5, a capacitor 6, a bidirectional chopper 7, an inverter 8, an operating unit 9, and a control device 10.

Bypass input terminal T1 receives AC power having a predetermined frequency (for example, a commercial frequency) from a bypass AC power supply 11 (a first AC power supply). Input terminal T2 receives AC power having a predetermined frequency (for example, the commercial frequency) from an AC power supply 12 (a second AC power supply). Each of AC power supplies 11 and 12 may be a commercial AC power supply, or may be a power generator. Both of AC power supplies 11 and 12 may be commercial AC power supplies.

DC terminal T3 is connected to a battery 13. Battery 13 (a power storage device) stores DC power. A capacitor may be connected instead of battery 13. Output terminal T4 is connected to a load 14. Load 14 is driven by AC power having a predetermined frequency (for example, the commercial frequency) supplied from the uninterruptible power supply device.

Semiconductor switch 1 is connected between input terminal T1 and output terminal T4. Semiconductor switch 1 includes a pair of thyristors 2 and 3 connected in anti-parallel with each other, and is controlled by control device 10.

When the AC power is normally supplied from bypass AC power supply 11 (when bypass AC power supply 11 is normal), semiconductor switch 1 is turned on, and the AC power is supplied from bypass AC power supply 11 to load 14 via semiconductor switch 1.

When the AC power is not normally supplied from bypass AC power supply 11 (when bypass AC power supply 11 has a power failure), semiconductor switch 1 is turned off, and the connection between bypass AC power supply 11 and load 14 is cut off.

An instantaneous value of an AC input voltage VI supplied from bypass AC power supply 11 is detected by control device 10. Based on the instantaneous value of AC input voltage VI, control device 10 determines whether or not AC voltage VI is normally supplied from bypass AC power supply 11.

Switch S1 is connected between input terminal T2 and an AC node of converter 4, and is controlled by control device 10. When the AC power is normally supplied from AC power supply 12 (when AC power supply 12 is normal), switch S1 is turned on, and the AC power is supplied from AC power supply 12 to converter 4 via switch S1. When the AC power is not normally supplied from AC power supply 12 (when AC power supply 12 has a power failure), switch S1 is turned off, and the connection between AC power supply 12 and converter 4 is cut off.

An instantaneous value of an AC input voltage Vi supplied from AC power supply 12 is detected by control device 10. Based on the instantaneous value of AC input voltage Vi, control device 10 determines whether or not AC voltage Vi is normally supplied from AC power supply 12. Current detector CD1 detects an AC input current Ii flowing between AC power supply 12 and converter 4, and provides a signal Iif indicating a detection value thereof to control device 10.

Converter 4 (a converter) is controlled by control device 10, and when AC power supply 12 is normal), converter 4 converts the AC power from AC power supply 12 into DC power and outputs it to DC line 5. Converter 4 is a well-known one including sets of IGBTs (Insulated Gate Bipolar Transistors) and diodes.

Capacitor 6 is connected to DC line 5 to smooth and stabilize a DC voltage VD of DC line 5. An instantaneous value of DC voltage VD of DC line 5 is detected by control device 10.

When AC power supply 12 is normal, control device 10 controls converter 4 such that DC voltage VD of DC line 5 is set to a reference DC voltage VDR. When AC power supply 12 has a power failure, control device 10 stops the operation of converter 4.

DC line 5 is connected to DC terminal T3 via bidirectional chopper 7 and switch S2. Switch S2 is controlled by control device 10. Switch S2 is turned on when the uninterruptible power supply device is used. Switch S2 is turned off during the maintenance of battery 13 and bidirectional chopper 7.

An instantaneous value of a terminal-to-terminal voltage VB of battery 13 is detected by control device 10. Current detector CD2 detects a DC current IB flowing between battery 13 and bidirectional chopper 7, and provides a signal IBf indicating a detection value thereof to control device 10.

Bidirectional chopper 7 is controlled by control device 10, and transmits and receives the DC power between DC line 5 and battery 13. Bidirectional chopper 7 is a well-known one including sets of IGBTs and diodes and a reactor.

When AC power supply 12 is normal, control device 10 controls bidirectional chopper 7 such that battery voltage VB is set to a reference DC voltage VBR. When AC power supply 12 has a power failure, control device 10 controls bidirectional chopper 7 such that DC voltage VD of DC line 5 is set to reference DC voltage VDR.

Converter 4, bidirectional chopper 7, and battery 13 constitute one embodiment of a “DC power supply” that supplies DC power to inverter 8.

Further, DC line 5 is connected to a DC node of inverter 8, and an AC node of inverter 8 is connected to a node N1 between semiconductor switch 1 and output terminal T4, via switch S3.

Switch S3 is controlled by control device 10. Switch S3 is turned on when the uninterruptible power supply device is used. Switch S3 is turned off during the maintenance of inverter 8.

Current detector CD3 detects an AC output current IO of inverter 8, and provides a signal IOf indicating a detection value thereof to control device 10. Current detector CD4 detects a load current IL flowing from node N1 to load 14, and provides a signal ILf indicating a detection value thereof to control device 10. Further, an instantaneous value of an AC output voltage VO to be applied to load 14 is detected by control device 10.

Inverter 8 (an inverter) is controlled by control device 10, and converts the DC power supplied from converter 4 and bidirectional chopper 7 via DC line 5 into AC power having a predetermined frequency (for example, the commercial frequency) and supplies it to load 14. Inverter 8 is a well-known one including sets of IGBTs and diodes.

When bypass AC power supply 11 has a power failure, inverter 8 converts the DC power supplied from converter 4 or bidirectional chopper 7 into AC power and supplies it to load 14. On this occasion, control device 10 controls inverter 8 such that AC output voltage VO is maintained at AC input voltage VI before the power failure occurs.

If load current IL is less than or equal to a threshold current Ith when bypass AC power supply 11 is normal, inverter 8 is set to a standby state in which it does not transmit and receive a current to and from bypass AC power supply 11 and load 14. Threshold current Ith is a rated current of semiconductor switch 1, for example. On this occasion, control device 10 controls inverter 8 such that AC output current IO of inverter 8 is set to 0 A.

If load current IL is larger than threshold current Ith when bypass AC power supply 11 is normal, inverter 8 supplies an assist current Ia=IL−Ith, which is a difference between load current IL and threshold current Ith, to load 14. On this occasion, control device 10 controls inverter 8 such that AC output current IO is set to assist current Ia.

Operating unit 9 includes a plurality of buttons, a plurality of switches, and an image display unit. By operating operating unit 9, a user of the uninterruptible power supply device can turn on and off a power supply of the uninterruptible power supply device, automatically or manually operate the uninterruptible power supply device, and set threshold current Ith to a desired value. Operating unit 9 outputs a signal and information indicating contents operated by the user to control device 10.

Control device 10 controls semiconductor switch 1, switches S1 to S3, converter 4, bidirectional chopper 7, and inverter 8, based on the signal from operating unit 9, AC input voltages VI and Vi, AC output voltage VO, DC voltage VD, battery voltage VB, AC input current Ii, battery current IB, AC output current IO, and load current IL.

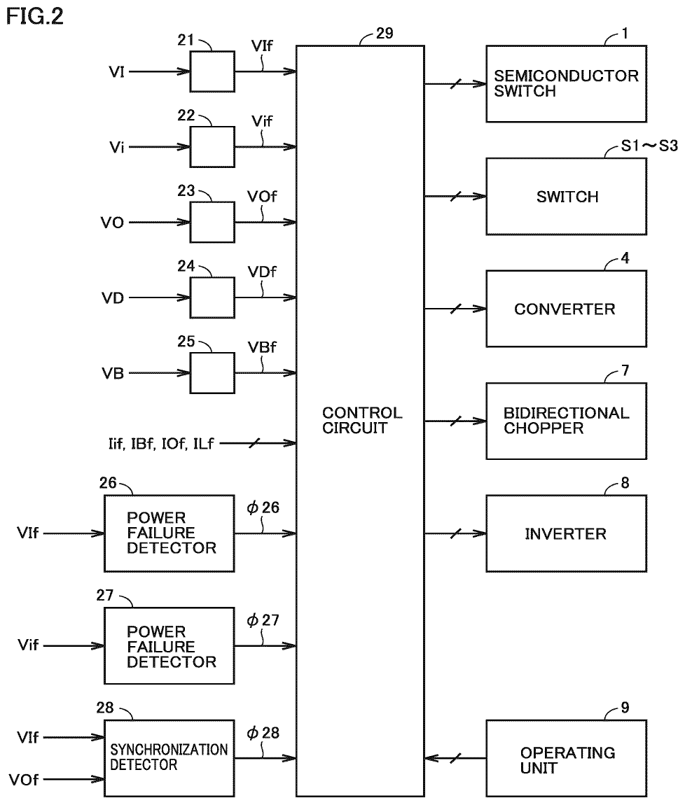

FIG. 2 is a block diagram showing a main portion of control device 10. In FIG. 2, control device 10 includes voltage detectors 21 to 25, power failure detectors 26 and 27, a synchronization detector 28, and a control circuit 29.

Voltage detector 21 detects the instantaneous value of AC input voltage VI supplied from bypass AC power supply 11, and outputs a signal VIf indicating a detection value thereof to power failure detector 26 and control circuit 29. Voltage detector 22 detects the instantaneous value of AC input voltage Vi supplied from AC power supply 12, and outputs a signal Vif indicating a detection value thereof to power failure detector 27 and control circuit 29. Voltage detector 23 detects the instantaneous value of AC output voltage VO to be applied to load 14, and outputs a signal VOf indicating a detection value thereof to control circuit 29.

Voltage detector 24 detects the instantaneous value of DC voltage VD of DC line 5, and outputs a signal VDf indicating a detection value thereof to control circuit 29. Voltage detector 25 detects the instantaneous value of terminal-to-terminal voltage VB of battery 13, and outputs a signal VBf indicating a detection value thereof to control circuit 29. Output signals Iif, IBf, IOf, and ILf of current detectors CD1 to CD4 (FIG. 1) are provided to control circuit 29.

Power failure detector 26 detects whether or not a power failure occurs in bypass AC power supply 11 based on output signal VIf of voltage detector 21, and outputs a power failure detection signal ϕ26 indicating a detection result thereof to control circuit 29. When bypass AC power supply 11 is normal, power failure detection signal ϕ26 is set to an “H” level, which is a deactivated level. When a power failure occurs in bypass AC power supply 11, power failure detection signal ϕ26 is set to an “L” level, which is an activated level.

For example, when AC input voltage VI is higher than a lower limit value, power failure detector 26 determines that bypass AC power supply 11 is normal, and sets power failure detection signal 026 to the “H” level, which is the deactivated level. Further, when AC input voltage VI is lower than the lower limit value, power failure detector 26 determines that a power failure occurs in bypass AC power supply 11, and sets power failure detection signal ϕ26 to the “L” level, which is the activated level.

Power failure detector 27 detects whether or not a power failure occurs in AC power supply 12 based on output signal Vif of voltage detector 22, and outputs a power failure detection signal 427 indicating a detection result thereof to control circuit 29. When AC power supply 12 is normal, power failure detection signal ϕ27 is set to an “H” level, which is a deactivated level. When a power failure occurs in AC power supply 12, power failure detection signal ϕ27 is set to an “L” level, which is an activated level.

For example, when AC input voltage Vi is higher than a lower limit value, power failure detector 27 determines that AC power supply 12 is normal, and sets power failure detection signal ϕ27 to the “H” level, which is the deactivated level. Further, when AC input voltage Vi is lower than the lower limit value, power failure detector 27 determines that a power failure occurs in AC power supply 12, and sets power failure detection signal ϕ27 to the “L” level, which is the activated level.

Synchronization detector 28 determines whether or not the frequency and the phase of AC input voltage VI match the frequency and the phase of AC output voltage VO, and outputs a signal ϕ28 indicating a determination result. When the frequency and the phase of AC input voltage VI match the frequency and the phase of AC output voltage VO, signal ϕ28 is set to an “H” level, and otherwise, signal ϕ28 is set to an “L” level.

Control circuit 29 controls the entire uninterruptible power supply device, based on output signals VIf, Vif, VOf, VDf, and VBf of voltage detectors 21 to 25, output signals Iif, IBf, IOf, and ILf of current detectors CD1 to CD4, signals ϕ26, ϕ27, and ϕ28, and the signal from operating unit 9.

That is, when AC power supplies 11 and 12 are normal (ϕ26=H, ϕ27=H), control circuit 29 turns on semiconductor switch 1 and switches S1 to S3, controls converter 4 such that DC voltage VD of DC line 5 is set to reference DC voltage VDR, and controls bidirectional chopper 7 such that battery voltage VB is set to reference DC voltage VBR.

When load current IL is less than or equal to threshold current Ith, control circuit 29 performs a bypass power feed mode, and sets inverter 8 to the standby state. In this case, the AC power is supplied from bypass AC power supply 11 to load 14 via semiconductor switch 1, and load 14 is operated.

Further, when load current IL is larger than threshold current Ith, control circuit 29 performs an inverter-assisted power feed mode, and controls inverter 8 such that AC output current IO of inverter 8 is set to assist current Ia=IL−Ith.

In this case, threshold current Ith is supplied from bypass AC power supply 11 to load 14 via semiconductor switch 1 and assist current Ia is supplied from inverter 8 to load 14, and load 14 is operated by load current IL=Ith+Ia, which is the sum of threshold current Ith and assist current Ia.

Therefore, even if load current IL is increased by load variation, the current flowing through semiconductor switch 1 is maintained at threshold current Ith or lower, and thus there is no need to turn off semiconductor switch 1 in order to prevent overheating of semiconductor switch 1. Accordingly, an uninterruptible power supply device that is tolerant of load variation can be implemented. Further, since there is no need to use semiconductor switch 1 having a large capacity in preparation for an increase in load current IL, device downsizing and cost reduction can be achieved. When a power failure occurs in bypass AC power supply 11 (ϕ26=L), control

circuit 29 performs a battery power feed mode, and turns off semiconductor switch 1 and controls inverter 8 such that AC output voltage VO of inverter 8 is maintained at AC input voltage VI before the power failure occurs. In this case, load current IL is supplied from inverter 8 to load 14, and load 14 is operated. Therefore, even if a power failure occurs in bypass AC power supply 11, the operation of load 14 can be continued when AC power supply 12 is normal.

When bypass AC power supply 11 recovers from a power failure state to a normal state, control circuit 29 synchronizes AC output voltage VO of inverter 8 with AC input voltage VI from bypass AC power supply 11. When the frequency and the phase of AC output voltage VO match the frequency and the phase of AC input voltage VI and output signal ϕ28 of synchronization detector 28 is set to the “H” level, control circuit 29 turns on semiconductor switch 1.

When a power failure occurs in AC power supply 12 (ϕ27=L), control circuit 29 turns off switch S1, stops the operation of converter 4, and controls bidirectional chopper 7 such that DC voltage VD of DC line 5 is set to reference DC voltage VDR. Therefore, even if a power failure occurs in AC power supplies 11 and 12, the operation of load 14 can be continued while the DC power is stored in battery 13.

When AC power supply 12 recovers from a power failure state to a normal state (ϕ27=L), control circuit 29 turns on switch S1, starts the operation of converter 4, controls converter 4 such that DC voltage VD of DC line 5 is set to reference DC voltage VDR, and controls bidirectional chopper 7 such that battery voltage VB is set to reference DC voltage VBR.

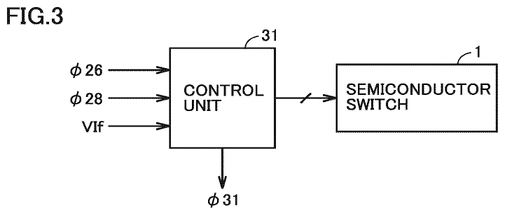

FIG. 3 is a block diagram showing a portion related to the control of semiconductor switch 1, of control circuit 29. In FIG. 3, control circuit 29 includes a control unit 31. Control unit 31 controls semiconductor switch 1 and generates a control signal ϕ31, based on output signal ϕ26 of power failure detector 26 (FIG. 2), output signal ϕ28 of synchronization detector 28, and output signal VIf of voltage detector 21.

That is, when bypass AC power supply 11 (FIG. 1) is normal (ϕ26=H), control unit 31 controls thyristors 2 and 3 in synchronization with AC input voltage VI indicated by output signal VIf of voltage detector 21, to turn on semiconductor switch 1. When a power failure occurs in bypass AC power supply 11 (FIG. 1) (ϕ26=L), control unit 31 turns off semiconductor switch 1.

When bypass AC power supply 11 recovers from the power failure state to the normal state (ϕ26=H), and the frequency and the phase of AC output voltage VO of inverter 8 match the frequency and the phase of AC input voltage VI from bypass AC power supply 11 (ϕ28=H), control unit 31 turns on semiconductor switch 1.

Control signal ϕ31 is a signal indicating the state of semiconductor switch 1. When semiconductor switch 1 is turned off, control signal ϕ31 is set to an “H” level. When semiconductor switch 1 is turned on, control signal ϕ31 is set to an “L” level. Control signal ϕ31 will be described later.

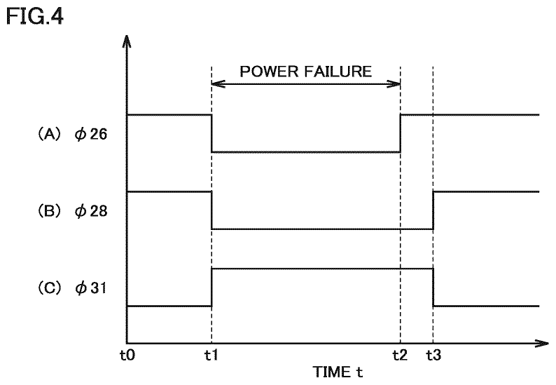

FIG. 4(A) to (C) is a time chart showing an operation of control unit 31. In FIG. 4, (A) shows a waveform of output signal ϕ26 of power failure detector 26 (FIG. 2), (B) shows a waveform of output signal ϕ28 of synchronization detector 28 (FIG. 2), and (C) shows a waveform of control signal ϕ31.

At a time instant t0, it is assumed that bypass AC power supply 11 is normal and semiconductor switch 1 is turned on. On this occasion, output signal $26 of power failure detector 26 is set to the “H” level. Further, since semiconductor switch 1 is turned on, the frequency and the phase of AC input voltage VI match the frequency and the phase of AC output voltage VO, and output signal ϕ28 of synchronization detector 28 is set to the “H” level. Further, since semiconductor switch 1 is turned on, control signal ϕ31 is set to the “L” level.

Then, when a power failure occurs in bypass AC power supply 11 at a time instant t1, both signals ϕ26 and ϕ28 fall from the “H” level to the “I,” level, semiconductor switch 1 is turned off, and control signal ϕ31 rises to the “H” level.

Then, when bypass AC power supply 11 recovers from the power failure state to the normal state at a time instant t2, signal ϕ26 rises from the “L” level to the “H” level. Then, when the frequency and the phase of AC output voltage VO of inverter 8 match the frequency and the phase of AC input voltage VI from bypass AC power supply 11 at a time instant t3, signal ϕ28 rises from the “L” level to the “H” level. Thereby, semiconductor switch 1 is turned on, and control signal ϕ31 falls from the “H” level to the “L” level.

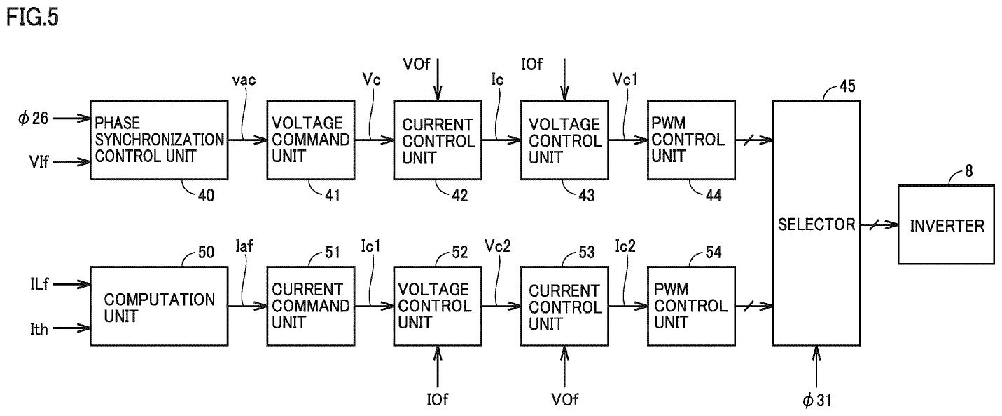

FIG. 5 is a block diagram showing a portion related to the control of inverter 8, of control circuit 29. In FIG. 5, control circuit 29 includes a phase synchronization control unit 40, a voltage command unit 41, current control units 42 and 53, voltage control units 43 and 52, PWM (Pulse Width Modulation) control units 44 and 54, a selector 45, a computation unit 50, and a current command unit 51.

When bypass AC power supply 11 is normal (ϕ26=H), phase synchronization control unit 40 outputs an AC signal vac having the same frequency and phase as those of AC input voltage VI indicated by output signal VIf of voltage detector 21 (FIG. 2).

When a power failure occurs in bypass AC power supply 11 (ϕ26=L), phase synchronization control unit 40 continues an output of AC signal vac before the power failure occurs. When bypass AC power supply 11 recovers from the power failure state to the normal state, phase synchronization control unit 40 controls the frequency and the phase of AC signal vac such that the frequency and the phase of AC signal vac match the frequency and the phase of AC input voltage VI.

Voltage command unit 41 outputs a voltage command value Vc having the same frequency and phase as those of AC signal vac. Current control unit 42 obtains a deviation ΔV=Vc−VO between voltage command value Vc and AC output voltage VO indicated by output signal VOf of voltage detector 23 (FIG. 2), and generates a current control value Ic such that deviation ΔV is eliminated.

Voltage control unit 43 obtains a deviation AI=Ic−IO between current control value Ic from current control unit 42 and AC output current IO indicated by output signal IOf of current detector CD3 (FIG. 1), and generates a voltage control value Vc1 such that deviation ΔI is eliminated.

Selector 45 couples PWM control unit 44 to inverter 8 when control signal ϕ31 (FIG. 3, FIG. 4) is at the “H” level, and couples PWM control unit 54 to inverter 8 when control signal 031 is at the “L” level.

PWM control unit 44 is coupled to inverter 8 by selector 45 when control signal ϕ31 is at the “H” level. PWM control unit 44 generates a PWM signal according to voltage control value Vc1, and controls inverter 8 by the PWM signal.

Computation unit 50 compares the magnitude of load current IL indicated by output signal ILf of current detector CD4, with the magnitude of threshold current Ith. In the case of IL>Ith, computation unit 50 subtracts threshold current Ith from load current IL to obtain assist current Ia=IL−Ith, and outputs a signal Iaf indicating assist current Ia to current command unit 51. In the case of IL≤Ith, computation unit 50 sets assist current Ia to 0 A, and outputs signal Iaf indicating that assist current Ia is 0 A to current command unit 51.

Current command unit 51 generates a current command value Ic1, which is a value according to assist current Ia indicated by signal Iaf. Current command value Ic1 is a sine wave signal having the same frequency and phase as those of load current IL.

Voltage control unit 52 obtains a deviation ΔI=Ic1−IO between current command value Ic1 from current command unit 51 and AC output current IO of inverter 8 indicated by output signal IOf of current detector CD3, and generates a voltage control value Vc2 such that deviation ΔI is eliminated.

Current control unit 53 obtains a deviation ΔV=Vc2−VO between voltage control value Vc2 and AC output voltage VO indicated by output signal VOf of voltage detector 23 (FIG. 2), and generates a current control value Ic2 such that deviation ΔV is eliminated.

PWM control unit 54 is coupled to inverter 8 by selector 45 when control signal ¢31 is at the “L” level. PWM control unit 54 generates a PWM signal according to current control value Ic2, and controls inverter 8 by the PWM signal.

Here, an operation of control circuit 29 shown in FIG. 5 will be described. When control unit 31 (FIG. 3) turns on semiconductor switch 1 to set control signal ϕ31 to the “L” level, selector 45 couples PWM control unit 54 to inverter 8.

Computation unit 50 compares the magnitudes of load current IL and threshold current Ith, and in the case of IL>Ith, computation unit 50 generates signal Iaf indicating assist current Ia=IL−Ith, and in the case of IL≤Ith, computation unit 50 generates signal Iaf indicating that assist current Ia is 0 A.

Current command unit 51 generates current command value Ic1, which is a value according to assist current Ia, and voltage control unit 52 generates voltage command value Vc2, which is a value according to deviation ΔI=Ic1−IO between current command value Ic1 and output current IO of inverter 8. Further, current control unit 53 generates current command value Ic2, which is a value according to deviation ΔV=Vc2−VO between voltage command value Vc2 and AC output voltage VO. PWM control unit 54 controls output current IO of inverter 8 according to current command value Ic2. Thereby, assist current la is supplied from inverter 8 to load 14.

Further, when control unit 31 (FIG. 3) turns off semiconductor switch 1 to set control signal ϕ31 to the “H” level, selector 45 couples PWM control unit 44 to inverter 8.

Phase synchronization control unit 40 generates AC signal vac having the same frequency and phase as those of AC input voltage VI, and voltage command unit 41 generates voltage command value Vc having the same frequency and phase as those of AC signal vac.

Further, current control unit 42 generates current command value Ic, which is a value according to deviation ΔV=Vc−VO between voltage command value Vc and AC output voltage VO. Voltage control unit 43 generates voltage command value Vc1, which is a value according to deviation ΔI=Ic−IO between current command value Ic and output current IO of inverter 8. PWM control unit 44 controls output voltage VO of inverter 8 according to voltage command value Vc1. Thereby, even if a power failure occurs in bypass AC power supply 11, AC voltage VO is supplied from inverter 8 to load 14, and the operation of load 14 is continued.

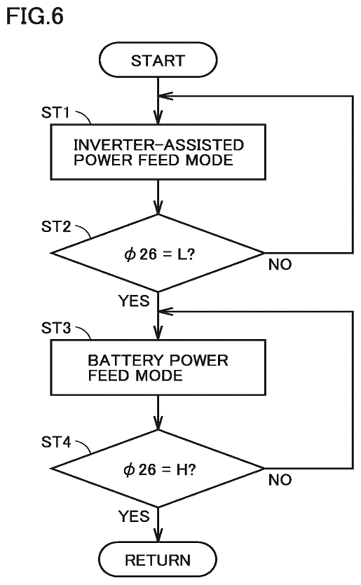

FIG. 6 is a flowchart showing an operation of the uninterruptible power supply device shown in FIGS. 1 to 5. However, in order to simplify the description, it is assumed that both AC power supplies 11 and 12 are commercial AC power supplies.

If the power supply of the uninterruptible power supply device is turned on using operating unit 9 when bypass AC power supply 11 is normal, the inverter-assisted power feed mode is performed in step ST1. That is, semiconductor switch 1 is turned on, converter 4 is controlled such that DC voltage VD of DC line 5 is set to reference DC voltage VDR, and bidirectional chopper 7 is controlled such that battery voltage VB is set to reference DC voltage VBR.

Further, when load current IL is less than or equal to threshold current Ith, inverter 8 is set to the standby state. When load current IL exceeds threshold current Ith, inverter 8 supplies assist current Ia=IL−Ith to load 14.

In step ST2, it is determined whether or not a power failure occurs in bypass AC power supply 11, that is, whether or not power failure detection signal ϕ26 is at the

“L” level. When signal ϕ26 is not at the “L” level, the inverter-assisted power feed mode is continued in step ST1.

When signal ϕ26 is at the “L” level, the battery power feed mode is performed in step ST3. That is, semiconductor switch 1 is turned off, switch S1 is turned off, and the operation of converter 4 is stopped. Further, bidirectional chopper 7 is controlled such that DC voltage VD of DC line 5 is set to reference DC voltage VDR, and AC voltage VO is supplied from inverter 8 to load 14 and load 14 is operated.

In step ST4, it is determined whether or not bypass AC power supply 11 recovers to the normal state, that is, whether or not power failure detection signal ϕ26 is at the “H” level. When signal ϕ26 is not at the “H” level, the battery power feed mode is continued in step ST3. When signal ϕ26 is at the “H” level, the inverter-assisted power feed mode is performed in step ST1.

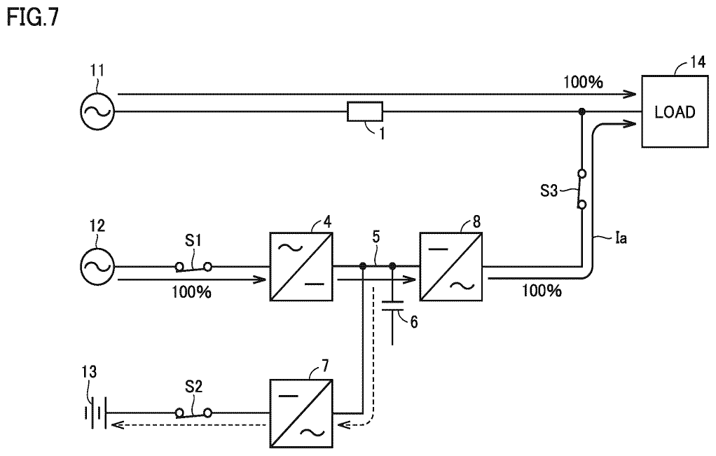

FIG. 7 is a circuit block diagram for describing an operation of the uninterruptible power supply device during the inverter-assisted power feed mode. In FIG. 7, in order to simplify the drawing and the description, terminals T1 to T4, current detectors CD1 to CD4, operating unit 9, and control device 10 (FIG. 1) are not shown. In FIG. 7, an arrow indicates a path through which power is supplied.

During the inverter-assisted power feed mode, semiconductor switch 1 is turned on, and the AC power is supplied from bypass AC power supply 11 to load 14 via semiconductor switch 1. Further, switches S1 to S3 are turned on, the AC power supplied from AC power supply 12 is converted into DC power by converter 4, and the DC power is stored in battery 13 by bidirectional chopper 7 and is also supplied to inverter 8.

When load current IL is less than or equal to threshold current Ith, inverter 8 is set to the standby state, and AC output current IO of inverter 8 is maintained at 0 A. When load current IL exceeds threshold current Ith, assist current Ia=IL−Ith for the exceeding portion is supplied from inverter 8 to load 14.

Here, it is assumed that the capacity of semiconductor switch 1, the capacity of converter 4, the capacity of bidirectional chopper 7, and the capacity of inverter 8 are set to the same value. Further, it is also assumed that each of semiconductor switch 1, converter 4, bidirectional chopper 7, and inverter 8 can supply 100% of power, and power consumption of load 14 varies from 100% to 200%.

When the power consumption of load 14 is 100%, 100% of power is supplied from bypass AC power supply 11 to load 14 via semiconductor switch 1. In this case, power supplied from inverter 8 to load 14 is maintained at 0%.

When the power consumption of load 14 varies and exceeds 100%, 100% of power is supplied from bypass AC power supply 11 to load 14 via semiconductor switch 1, and power for the exceeding portion is supplied from inverter 8 to load 14.

FIG. 7 shows a case where the power consumption of load 14 increases to 200%. In this case, 100% of power is supplied from bypass AC power supply 11 to load 14 via semiconductor switch 1, and 100% of power is supplied from AC power supply 12 to inverter 8 via converter 4 and 100% of power is supplied from inverter 8 to load 14. However, it is assumed that battery 13 has already been fully charged and the current flowing through battery 13 is sufficiently small.

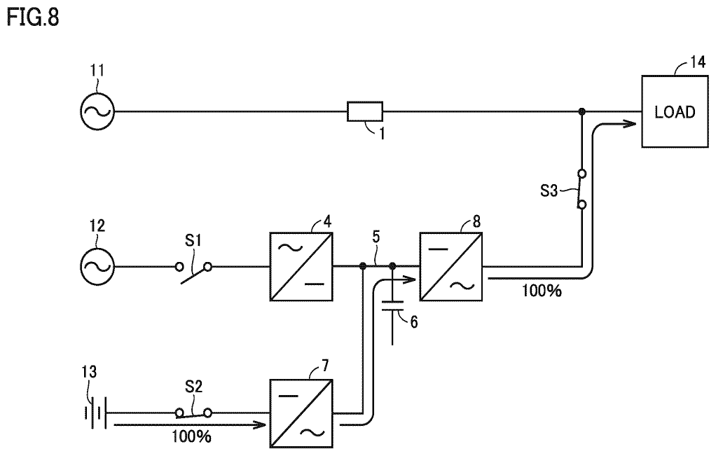

FIG. 8 is a circuit block diagram for describing an operation of the uninterruptible power supply device during the battery power feed mode, which is compared with FIG. 7. The battery power feed mode is performed when AC power supplies 11 and 12 have a power failure.

In this case, semiconductor switch 1 is turned off and the connection between bypass AC power supply 11 and load 14 is cut off, and switch S1 is turned off and the connection between AC power supply 12 and converter 4 is cut off and the operation of converter 4 is stopped. Further, 100% of power is supplied from battery 13 to inverter 8 via bidirectional chopper 7, and 100% of power is supplied from inverter 8 to load 14.

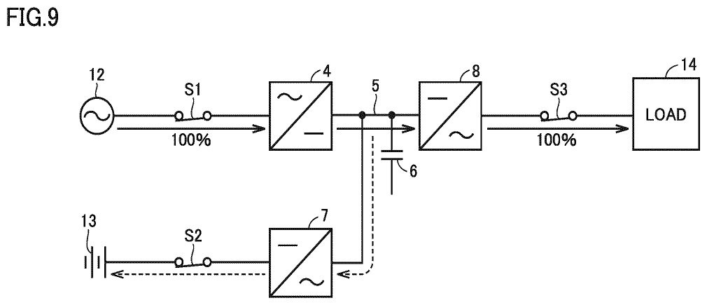

Here, in order to clarify the effect in the present embodiment, a conventional uninterruptible power supply device will be described as a comparative example. FIG. 9 is a circuit block diagram for describing an operation in a comparative example, which is compared with FIG. 7. Referring to FIG. 9, the comparative example is different from the present embodiment in that semiconductor switch 1 is removed.

When AC power supply 12 is normal, an inverter power feed mode is performed, in which switches S1 to S3 are turned on, the AC power supplied from AC power supply 12 is converted into DC power by converter 4, and the DC power is stored in battery 13 by bidirectional chopper 7 and is also converted into AC power by inverter 8 and supplied to load 14.

FIG. 9 shows a case where the power consumption of load 14 is 100%. In this case, 100% of power is supplied from AC power supply 12 to inverter 8 via converter 4 and 100% of power is supplied from inverter 8 to load 14. However, it is assumed that battery 13 has already been fully charged and the current flowing through battery 13 is sufficiently small.

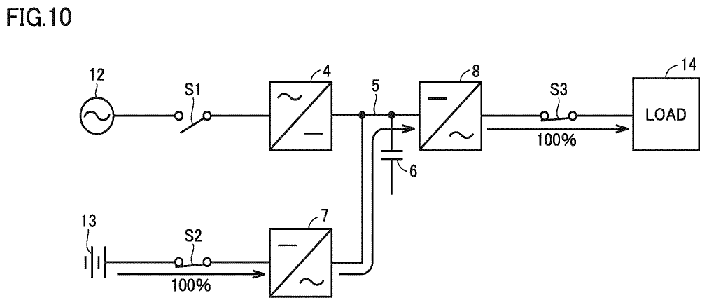

FIG. 10 is a circuit block diagram for describing another operation in the comparative example, which is compared with FIG. 9. In FIG. 10, when AC power supply 12 has a power failure, the battery power feed mode is performed. In this case, switch S1 is turned off and the connection between AC power supply 12 and converter 4 is cut off and the operation of converter 4 is stopped. Further, DC power is supplied from battery 13 to inverter 8 via bidirectional chopper 7, and the DC power is converted into AC power by inverter 8 and is supplied to load 14.

FIG. 10 shows a case where the power consumption of load 14 is 100%. In this case, further, 100% of power is supplied from battery 13 to inverter 8 via bidirectional chopper 7, and 100% of power is supplied from inverter 8 to load 14.

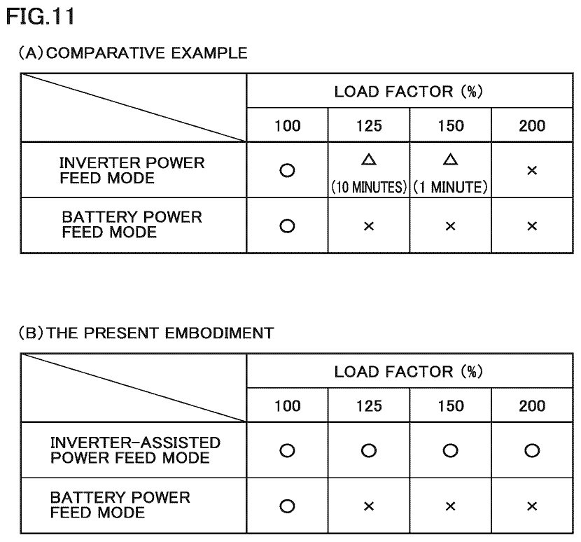

FIG. 11 is a view for describing an effect in the present embodiment. In FIG. 11, (A) is a view showing the performance in the comparative example, and (B) is a view showing the performance in the present embodiment. In the comparative example, as shown in FIG. 11(A), the inverter power feed mode is performed when AC power supply 12 is normal. When the power consumption of load 14 is 100%, that is, when a load factor thereof is 100%, load 14 can be stably operated (a circular mark).

However, when the load factor increases to 125%, the temperature of inverter 8 increases and reaches an upper limit temperature in 10 minutes, for example. Accordingly, it is necessary to stop the operation of inverter 8, and load 14 can be operated only for 10 minutes, for example (a triangular mark). When the load factor increases to 150%, the temperature of inverter 8 reaches the upper limit temperature in one minute, for example, and thus load 14 can be operated only for one minute, for example (a triangular mark). When the load factor increases to 200%, an overcurrent is sensed and the operation of inverter 8 is stopped, and the power supply to load 14 is stopped (an X-shaped mark).

Further, in the comparative example, the battery power feed mode is performed when AC power supply 12 has a power failure. When the power consumption of load 14 is 100%, that is, when the load factor is 100%, the operation of load 14 can be continued (a circular mark). When the load factor exceeds 125%, an overcurrent is sensed and the operation of inverter 8 is stopped, and the power supply to load 14 is stopped (an X-shaped mark).

In contrast, in the present embodiment, as shown in FIG. 11(B), the inverter-assisted power feed mode is performed when AC power supplies 11 and 12 are normal. When the load factor is 100%, 100% of power is supplied from bypass AC power supply 11 to load 14 via semiconductor switch 1, and thus load 14 can be stably operated (a circular mark).

Further, when the load factor is 100 to 200%, 100% of power is supplied from bypass AC power supply 11 to load 14 via semiconductor switch 1, and 0 to 100% of power for the exceeding portion is supplied from AC power supply 12 to load 14 via converter 4 and inverter 8, and thus load 14 can be stably operated (a circular mark).

Further, in the present embodiment, the battery power feed mode is performed when AC power supplies 11 and 12 have a power failure. When the load factor is 100%, the operation of load 14 can be continued (a circular mark). When the load factor exceeds 125%, an overcurrent is sensed and the operation of inverter 8 is stopped, and the power supply to load 14 is stopped (an X-shaped mark). This is the same as in the comparative example.

As described above, in the present embodiment, if load current IL is larger than threshold current Ith when bypass AC power supply 11 is normal, assist current Ia=IL−Ith, which is a difference between load current IL and threshold current Ith, is supplied from inverter 8 to load 14. Therefore, even if load current IL is increased by load variation, the current flowing through semiconductor switch 1 can be maintained at threshold current Ith or lower, and overheating of semiconductor switch 1 can be prevented. This can prevent semiconductor switch 1 from being turned off to stop the operation of load 14, and thus an uninterruptible power supply device that is tolerant of load variation can be implemented. Further, since there is no need to use semiconductor switch 1 having a large capacity in preparation for an increase in load current IL, device downsizing and cost reduction can be achieved.

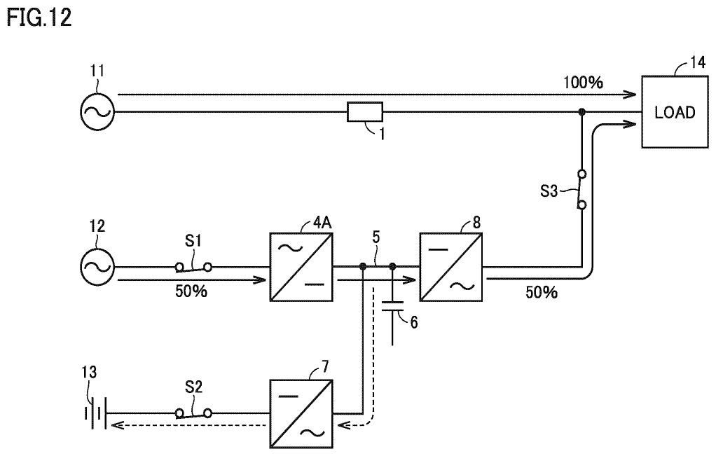

FIG. 12 is a circuit block diagram showing a variation of the embodiment, which is compared with FIG. 7. Referring to FIG. 12, this variation is different from the embodiment in that converter 4 is replaced by a converter 4A. The capacity (that is, the size) of converter 4A is reduced to X % of the capacity (that is, the size) of converter 4, where X is a real number that is larger than 0 and is smaller than 100. FIG. 12 shows the case of X=50.

In FIG. 12, the inverter-assisted power feed mode is performed when AC power supplies 11 and 12 are normal. When the load factor is 100%, 100% of power is supplied from bypass AC power supply 11 to load 14 via semiconductor switch 1. Further, when the load factor increases to 150%, 100% of power is supplied from bypass AC power supply 11 to load 14 via semiconductor switch 1, and 50% of power for the exceeding portion is supplied from AC power supply 12 to load 14 via converter 4 and inverter 8.

In this variation, the size of the converter can be downsized when compared with the embodiment, and thus device downsizing can be achieved.

It should be understood that the embodiment disclosed herein is illustrative and non-restrictive in every respect. The present invention is defined by the scope of the claims, rather than the description above, and is intended to include any modifications within the scope and meaning equivalent to the scope of the claims.

### REFERENCE SIGNS LIST

T1: bypass input terminal; T2: input terminal; T3: DC terminal; T4: output terminal; 1: semiconductor switch; 2, 3: thyristor; S1 to S3: switches; 4: converter; CD1 to CD4: current detectors; 5: DC Line; 6: capacitor; 7: bidirectional chopper; 8: inverter; 9: operating unit; 10: control device; 11: bypass AC power supply; 12: AC power supply; 13: battery; 14: load; 21 to 25: voltage detectors; 26, 27: power failure detector; 28: synchronization detector; 29: control circuit; 31: control unit; 40: phase synchronization control unit; 41: voltage command unit; 42, 53: current control unit; 43, 52: voltage control unit; 44, 54: PWM control unit; 45: selector; 50: computation unit; 51: current command unit.

1. An uninterruptible power supply device comprising:
a semiconductor switch that is connected between a first AC power supply and a load, is turned on when the first AC power supply is normal, and is turned off when the first AC power supply has a power failure; and
an inverter that converts DC power supplied from a DC power supply into AC power and supplies the AC power to the load when the first AC power supply has a power failure, and supplies an assist current to the load if a load current is larger than a threshold current when the first AC power supply is normal, the assist current being a difference between the load current and the threshold current.

2. The uninterruptible power supply device according to claim 1, wherein the threshold current is set to a rated current of the semiconductor switch or lower.

3. The uninterruptible power supply device according to claim 1, wherein, if the load current is smaller than the threshold current when the first AC power supply is normal, the inverter is set to a standby state in which the inverter does not transmit and receive a current to and from the first AC power supply and the load.

4. The uninterruptible power supply device according to claim 3, wherein
the DC power supply includes
a converter that converts AC power supplied from a second AC power supply into DC power, and
a power storage device that stores DC power,
if the load current is smaller than the threshold current when the first and second AC power supplies are normal, the DC power generated by the converter is stored in the power storage device, and the inverter is set to the standby state,
if the load current is larger than the threshold current when the first and second AC power supplies are normal, the inverter generates the assist current based on the DC power generated by the converter, and
when the first and second AC power supplies have a power failure, the DC power in the power storage device is converted into AC power by the inverter and is supplied to the load.

5. The uninterruptible power supply device according to claim 4, wherein a capacity of the converter is set to be smaller than a capacity of the inverter.
